(19) United States
(12) Patent Application Publication
(10) Pub. No.: US 2021/0397245 A1
(43) Pub. Date: Dec. 23, 2021

(54) INFORMATION PROCESSING SYSTEM, DISPLAY METHOD, AND COMPUTER PROGRAM

(71) Applicant: Sony Interactive Entertainment Inc., Tokyo (JP)

(72) Inventors: Koji Ohata, Tokyo (JP); Motohiko Akiyama, Tokyo (JP); Haruko Tsuge, Tokyo (JP)

(73) Assignee: Sony Interactive Entertainment Inc., Tokyo (JP)

(21) Appl. No.: 17/290,100

(22) PCT Filed: Nov. 6, 2018
(86) PCT No.: PCT/JP2018/041231

§ 371 Date: Apr. 29, 2021

(51) Int. Cl. G06F 3/01; A63F 13/213; A63F 13/55

(52) U.S. Cl. CPC G06F 3/011; A63F 2300/8082; A63F 13/55; A63F 13/213

(57) ABSTRACT

An attribute acquisition section acquires, from an external apparatus, attribute information regarding a first object that moves in response to an action of a user in a real space. An image generation section generates a virtual reality image which includes an object image representing a second object that moves in response to an action of the user in a virtual reality space and in which the second object behaves according to the attribute information acquired by the attribute acquisition section. An image output section causes a display apparatus to display the virtual reality image generated by the image generation section.

### TECHNICAL FIELD

The present invention relates to a data processing technique, and in particular, to an information processing system, a display method, and a computer program.

### BACKGROUND ART

A system has been developed that displays a panoramic image on a head-mounted display and, in response to the rotation of the head of the user wearing the head-mounted display, that displays a panoramic image corresponding to the gaze direction. The use of the head-mounted display can enhance a sense of immersion in a virtual reality space.

[Citation List] [Patent Literature]

[PTL 1] WO 2017/110632

### SUMMARY

### Technical Problem

While various applications that allow the user to experience the virtual reality space have been provided, there is a need of providing a highly entertaining viewing experience to the user viewing the virtual reality space.

The present invention has been made in view of the issue above, and it is an object of the present invention to provide a highly entertaining viewing experience to the user viewing the virtual reality space.

### Solution to Problem

In order to solve the issue described above, an information processing system according to an aspect of the present invention includes an acquisition section configured to acquire, from an external apparatus, attribute information regarding a first object that moves in response to an action of a user in a real space, a generation section configured to generate a virtual reality image which includes an object image representing a second object that moves in response to an action of the user in a virtual reality space and in which the second object behaves according to the attribute information acquired by the acquisition section, and an output section configured to cause a display apparatus to display the virtual reality image generated by the generation section.

Another aspect of the present invention is a display method. The method is performed by a computer and includes a step of acquiring, from an external apparatus, attribute information regarding a first object that moves in response to an action of a user in a real space, a step of generating a virtual reality image which includes an object image representing a second object that moves in response to an action of the user in a virtual reality space and in which the second object behaves according to the attribute information acquired by the step of acquiring, and a step of causing a display apparatus to display the virtual reality image generated by the step of generating.

It is noted that any combinations of the constituent components described above and the expressions of the present invention that are converted between an apparatus, a computer program, a recording medium in which the computer program is readably recorded, a head-mounted display including the functions of the information processing apparatus described above, and the like are also effective as aspects of the present invention.

### Advantageous Effect of Invention

According to the present invention, a highly entertaining viewing experience can be provided to the user viewing a virtual reality space.

### BRIEF DESCRIPTION OF DRAWINGS

FIG. 1 is a diagram illustrating a configuration of an entertainment system according to an embodiment.

FIG. 2 is a view illustrating an external shape of an HMD (Head-Mounted Display) of FIG. 1.

FIG. 3 is a block diagram illustrating functional blocks of the HMD of FIG. 1.

FIG. 4 is a block diagram illustrating functional blocks of an information processing apparatus of FIG. 1.

FIG. 5 is a view illustrating an example of a VR (Virtual Reality) image.

FIG. 6 is a view illustrating an example of the VR image.

### DESCRIPTION OF EMBODIMENT

First, an overview of an entertainment system according to an embodiment will be described. The entertainment system according to the embodiment is an information processing system that causes a head-mounted display (hereinafter also referred to as an “HMD”) worn on the user's head to display a virtual reality space in which video content such as a movie, a concert, an animation, or a game video is reproduced. Hereinafter, unless otherwise specified, an “image” in the embodiment may include both a moving image and a still image.

The virtual reality space according to the embodiment is a virtual movie theater (hereinafter also referred to as a “VR movie theater”) that includes a lobby and a screen room. In the lobby, a ticket counter for purchasing the right to view video content (i.e., a ticket) and a store where goods and food can be purchased are installed. In the screen room, a screen on which video content is to be reproduced and displayed and seats on which viewers including the user are to be seated are installed.

In the lobby and the screen room, an avatar of the user, an avatar of the user's friend, the user's pet, and a dummy character (i.e., an NPC (Non Player Character)) are displayed. The friend is invited by the user to join the user's session (also referred to as a “game session”). In the screen room, the user views video content together with the friend, the pet, and the dummy character. Further, the user can also voice chat with the friend who has joined the user's session.

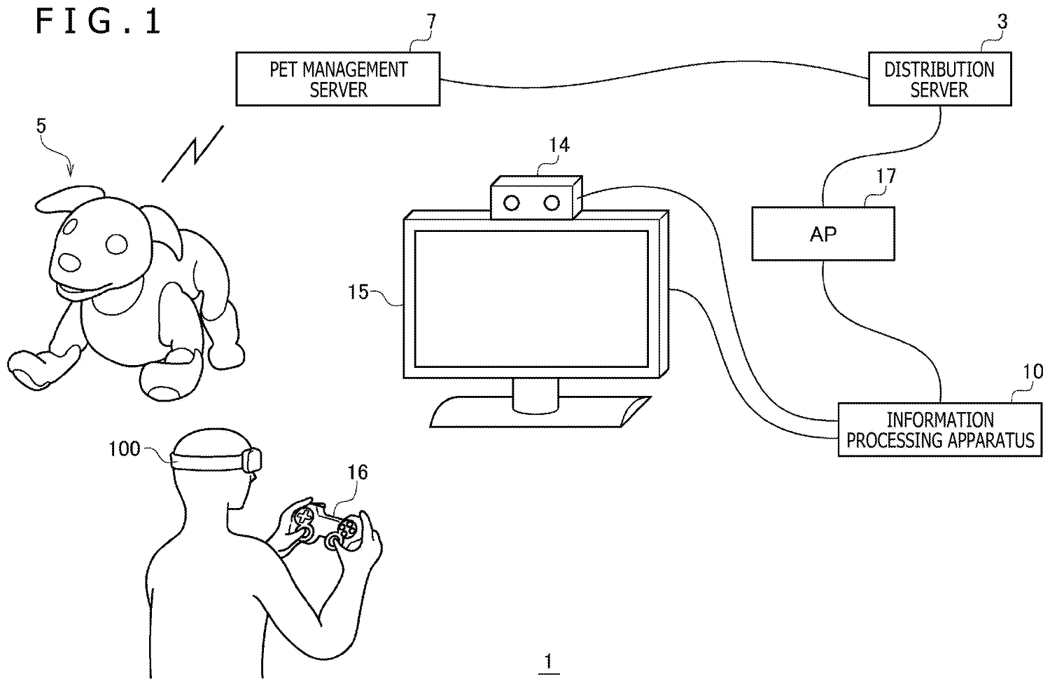

FIG. 1 illustrates a configuration of an entertainment system 1 according to the embodiment. The entertainment system 1 includes an information processing apparatus 10, an HMD 100, an input apparatus 16, an imaging apparatus 14, and an output apparatus 15. The input apparatus 16 is a controller of the information processing apparatus 10 that is operated by the user with the user's fingers. The output apparatus 15 is a television or a monitor that displays an image.

The information processing apparatus 10 performs various data processes for causing the HMD 100 to display a video of a virtual three-dimensional space (hereinafter also referred to as a “VR image”) representing the VR movie theater. The information processing apparatus 10 detects the user's gaze direction according to posture information of the HMD 100 and causes the HMD 100 to display a VR image corresponding to the gaze direction. The information processing apparatus 10 may be a PC (Personal Computer) or a game machine.

The imaging apparatus 14 is a camera apparatus that captures an image of a space at predetermined intervals. This space includes the user wearing the HMD 100 and is in the surroundings of the user. The imaging apparatus 14 is a stereo camera and supplies the captured image to the information processing apparatus 10. As described later, the HMD 100 is provided with markers (tracking LEDs (Light-Emitting Diode)) for tracking the user's head, and the information processing apparatus 10 detects the movement (e.g., position, posture, and their changes) of the HMD 100 on the basis of the positions of the markers included in the captured image.

It is noted that the HMD 100 includes a posture sensor (an acceleration sensor and a gyro sensor). The HMD 100 acquires sensor data detected by the posture sensor from the HMD 100 to perform highly accurate tracking processing together with the use of the captured image of the markers. It is noted that various methods have been conventionally proposed for tracking processing, and any of the tracking methods may be employed as long as the information processing apparatus 10 can detect the movement of the HMD 100.

Since the user views an image on the HMD 100, the output apparatus 15 is not necessarily required for the user wearing the HMD 100. However, providing the output apparatus 15 allows another user to view an image displayed on the output apparatus 15. The information processing apparatus 10 may cause the output apparatus 15 to display the same image as the image being viewed by the user wearing the HMD 100 or may cause the output apparatus 15 to display a different image. For example, in a case where the user wearing the HMD 100 and another user (such as a friend) view video content together, the output apparatus 15 may display the video content from a viewpoint of another user.

An AP 17 has functions of a wireless access point and a router. The information processing apparatus 10 may be connected to the AP 17 through a cable or a known wireless communication protocol. The information processing apparatus 10 may be connected to a distribution server 3 on an external network via the AP 17. The distribution server 3 transmits data of various pieces of video content to the information processing apparatus 10 in accordance with a predetermined streaming protocol.

The entertainment system 1 according to the embodiment further includes a pet robot 5 and a pet management server 7. The pet robot 5 is a known entertainment robot having a shape resembling an animal such as a dog or a cat. The pet robot 5 is regarded as a first object that interacts with the user in a real space and also acts (moves) in response to the action of the user.

Further, the pet robot 5 includes various sensors that function as a visual sense, an auditory sense, and a tactile sense. Further, a program for reproducing an emotion is installed in the pet robot 5. This program is executed by a CPU (Central Processing Unit), which is incorporated into the pet robot 5. With this program executed, the pet robot 5 varies the response to the same operation or stimulus so as to match the mood or the degree of growth at that time. While the pet robot 5 runs for a long period of time, the pet robot 5 gradually develops its own personality according to how the pet robot 5 has been treated.

Further, the pet robot 5 stores data (hereinafter also referred to as “learning data”) including the record of interaction with the user, the history of actions, the transition of emotion, and the like. The pet robot 5 also stores its own learning data in the pet management server 7. The pet management server 7 is an information processing apparatus that manages a behavior state and the like of the pet robot 5 and has a function of storing the learning data of the pet robot 5.

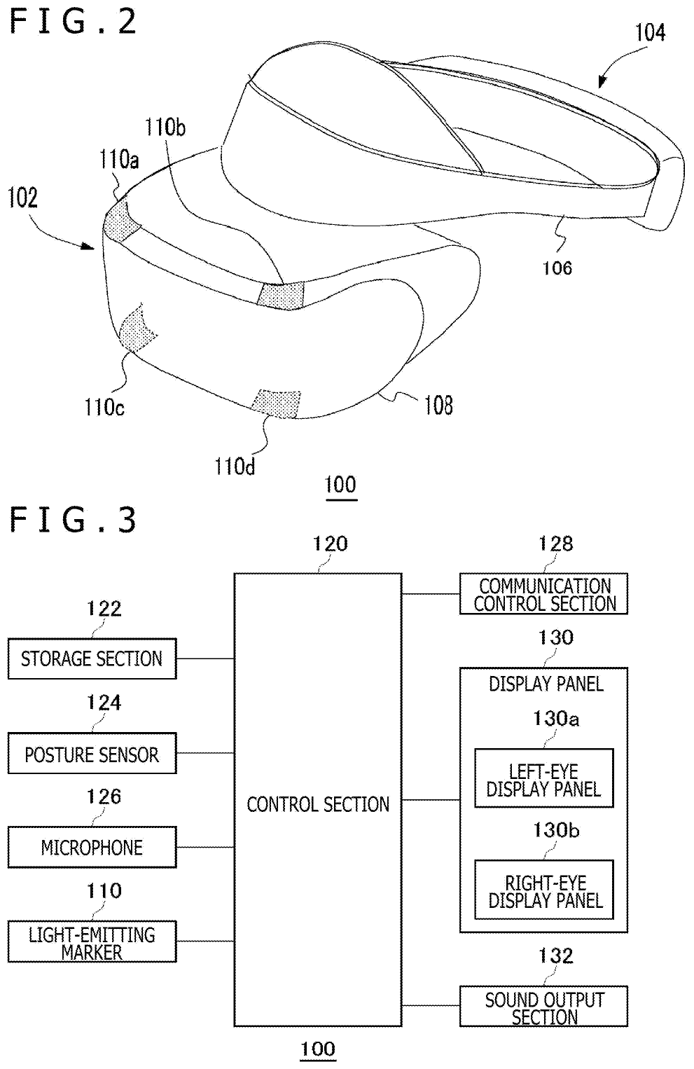

FIG. 2 illustrates an external shape of the HMD 100 of FIG. 1. The HMD 100 includes an output mechanism section 102 and a wearing mechanism section 104. The wearing mechanism section 104 includes a wearing band 106. With the wearing band 106 worn by the user, the wearing band 106 surrounds the head so as to fix the HMD 100 to the head. The wearing band 106 is made of a material or has a structure that can be adjusted in length so as to match the head circumference of the user.

The output mechanism section 102 includes a housing 108. The housing 108 is shaped so as to cover the right and left eyes with the HMD 100 worn by the user. The housing 108 includes, in its inside, display panels, which directly face the eyes when the HMD 100 is worn. The display panels may be liquid-crystal panels, organic EL panels, or the like. The housing 108 further includes, in its inside, a pair of right and left optical lenses that are positioned between the display panels and the user's eyes and enlarge the user's viewing angle. The HMD 100 may further include speakers or earphones at positions corresponding to the user's ears. The HMD 100 may be connected to external headphones.

The housing 108 includes, on its outer surface, light-emitting markers 110a, 110b, 110c, and 110d. Although, in this example, the tracking LEDs constitute the light-emitting markers 110, another type of markers may be used. In any case, any type of markers can be used as long as the imaging apparatus 14 can capture an image of the markers and the information processing apparatus 10 can analyze the positions of the markers in the image. Although there is no particular limitation on the number and arrangement of the light-emitting markers 110, the number and arrangement of the light-emitting markers 110 need to be adequate to be able to detect the posture of the HMD 100. In the illustrated example, the light-emitting markers 110 are disposed at four corners of a front surface of the housing 108. Moreover, the light-emitting markers 110 may also be disposed on side and rear portions of the wearing band 106 so that the imaging apparatus 14 can capture an image of the light-emitting markers 110 even when the user's back faces the imaging apparatus 14.

The HMD 100 may be connected to the information processing apparatus 10 through a cable or a known wireless communication protocol. The HMD 100 transmits sensor data detected by the posture sensor to the information processing apparatus 10 and receives image data generated by the information processing apparatus 10 to display the images on a left-eye display panel and a right-eye display panel.

FIG. 3 is a block diagram illustrating functional blocks of the HMD 100 of FIG. 1. The plurality of functional blocks illustrated in the block diagram in the present specification can be constituted by a circuit block, a memory, or another LSI (Large Scale Integration) in terms of hardware, and is implemented by, for example, the CPU executing a program loaded in a memory in terms of software. Therefore, it is to be understood by those skilled in the art that these functional blocks can be implemented in various forms by hardware only, software only, or combinations of hardware and software, and are not limited to any of these forms.

A control section 120 is a main processor that processes various data, such as image data, sound data, and sensor data, and instructions and outputs processing results. A storage section 122 temporarily stores data, instructions, and the like to be processed by the control section 120. A posture sensor 124 detects posture information of the HMD 100. The posture sensor 124 includes at least a three-axis acceleration sensor and a three-axis gyro sensor.

A communication control section 128 transmits data output from the control section 120 to the external information processing apparatus 10 through wired or wireless communication via a network adapter or an antenna. Further, the communication control section 128 receives data from the information processing apparatus 10 through wired or wireless communication via the network adapter or the antenna and outputs the data to the control section 120.

When the control section 120 receives image data and sound data from the information processing apparatus 10, the control section 120 supplies the image data to a display panel 130, causing the display panel 130 to display images, while supplying the sound data to a sound output section 132, causing the sound output section 132 to output the sound. The display panel 130 includes a left-eye display panel 130a and a right-eye display panel 130b. A pair of parallax images are displayed on the respective display panels. Further, the control section 120 also causes the communication control section 128 to transmit sensor data supplied from the posture sensor 124 and sound data supplied from a microphone 126 to the information processing apparatus 10.

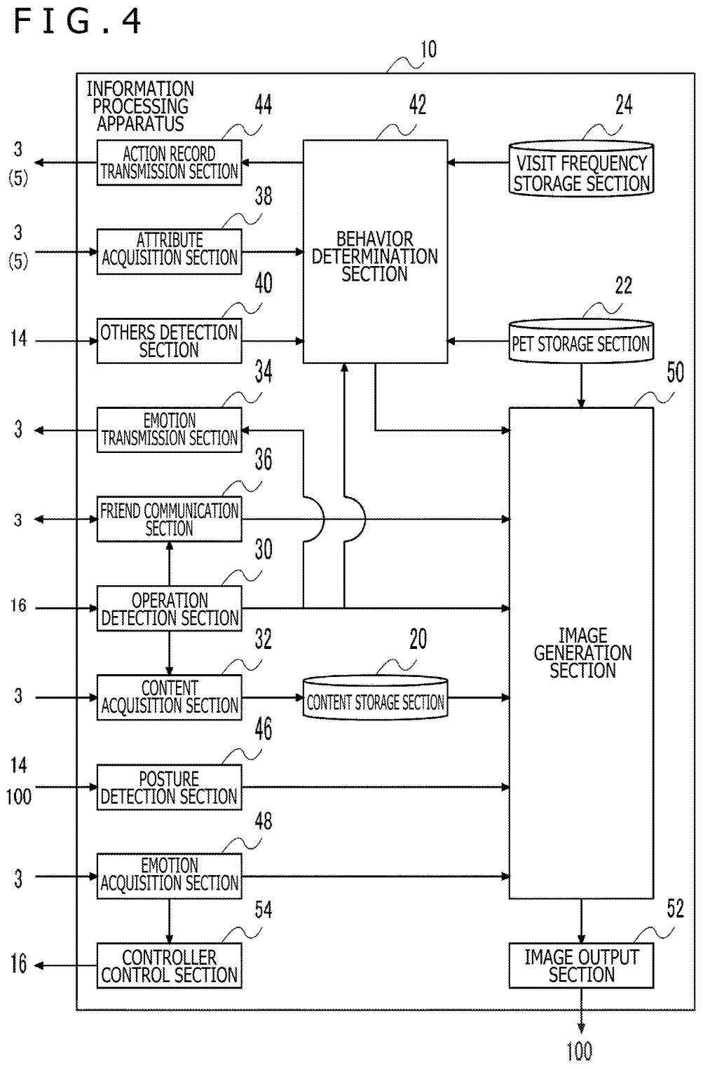

FIG. 4 is a block diagram illustrating functional blocks of the information processing apparatus 10 of FIG. 1. The information processing apparatus 10 includes a content storage section 20, a pet storage section 22, a visit frequency storage section 24, an operation detection section 30, a content acquisition section 32, an emotion transmission section 34, a friend communication section 36, an attribute acquisition section 38, an others detection section 40, a behavior determination section 42, an action record transmission section 44, a posture detection section 46, an emotion acquisition section 48, an image generation section 50, an image output section 52, and a controller control section 54.

At least some of the plurality of functional blocks illustrated in FIG. 4 may be implemented as modules of a computer program (a video viewing application in the embodiment). The video viewing application may be stored in a recording medium such as a DVD (Digital Versatile Disc), and the information processing apparatus 10 may read the video viewing application from the recording medium and store the video viewing application in storage. Further, the information processing apparatus 10 may download the video viewing application from a server on a network and store the video viewing application in storage. The CPU or a GPU (Graphics Processing Unit) of the information processing apparatus 10 may read the video viewing application in a main memory and execute the video viewing application, thereby performing the function of each functional block.

The content storage section 20 temporarily stores data of video content provided by the distribution server 3. The pet storage section 22 stores attribute information regarding a second object (hereinafter also referred to as a “VR pet”) that appears in a virtual reality space (the VR movie theater in the embodiment) and behaves as the user's pet. The VR pet is the second object that interacts with the user (user's avatar) in the VR movie theater and acts (moves) in response to the action of the user (user's avatar). The attribute information regarding the VR pet includes the user's name, the VR pet's name, image data of the VR pet, the record of interaction of the VR pet with the user, the history of actions of the user and the VR pet, transition of emotion of the VR pet, and the like.

The visit frequency storage section 24 stores data concerning the frequency with which the user has visited the virtual reality space (the VR movie theater in the embodiment). The visit frequency storage section 24 according to the embodiment stores data indicating the interval of the user's visit to the VR movie theater between last time and this time (that is, a period of time in which the user has not visited the VR movie theater). This data can also be said to be the interval of the user's activation of the video viewing application between last time and this time. As a modification, the visit frequency storage section 24 may store the number of user's visits (or may store the number of most recent visits or the average number of visits) in a predetermined unit of time (e.g., one week).

The operation detection section 30 detects user operation that is input into the input apparatus 16 and notified from the input apparatus 16. The operation detection section 30 notifies the other functional blocks of the detected user operation. The user operation that may be input during the execution of the video viewing application includes an operation indicating the type of emotion of the user. In the embodiment, the user operation that may be input during the execution of the video viewing application includes a button operation indicating that the user has a feeling of enjoyment (hereinafter also referred to as a “fun button operation”) and a button operation indicating that the user has a feeling of sadness (hereinafter also referred to as a “sad button operation”).

The emotion transmission section 34 transmits data indicating the user's emotion (hereinafter also referred to as “emotion data”) indicated by the input user operation to the distribution server 3. For example, in a case where the fun button operation has been input, the emotion transmission section 34 transmits emotion data indicating that the user has a feeling of enjoyment. In a case where the sad button operation has been input, the emotion transmission section 34 transmits emotion data indicating that the user has a feeling of sadness.

The content acquisition section 32 acquires, from the distribution server 3, data of video content specified by the user operation among the plurality of types of pieces of video content provided by the distribution server 3 and stores the data of the video content in the content storage section 20. For example, the content acquisition section 32 requests the distribution server 3 to provide a movie specified by the user and stores the video data of the movie above, which has been transmitted from the distribution server 3 by streaming, in the content storage section 20.

The friend communication section 36 communicates with an information processing apparatus of the user's friend according to the user operation. For example, the friend communication section 36 transmits a message inviting the friend to join the user's session, in other words, a message encouraging the friend to join the user's session, to the information processing apparatus of the friend via the distribution server 3.

The attribute acquisition section 38 acquires attribute information regarding the pet robot 5 from an external apparatus. In the embodiment, the attribute acquisition section 38 requests the learning data of the pet robot 5 from the distribution server 3 at the time of activation of the video viewing application. The distribution server 3 acquires the learning data of the pet robot 5, which has been transmitted from the pet robot 5 and registered in the pet management server 7, from the pet management server 7. The attribute acquisition section 38 acquires the learning data of the pet robot 5 from the distribution server 3 and passes the learning data of the pet robot 5 to the behavior determination section 42.

The others detection section 40 refers to a captured image output from the imaging apparatus 14, and in a case where a person different from the user wearing the HMD 100 on the head appears in the captured image, the others detection section 40 detects the appearance of the person different from the user. For example, assume that the state has changed from a state in which no person different from the user appears in the captured image to a state in which a person different from the user appears in the captured image. In this case, the others detection section 40 detects the appearance of the person different from the user in the vicinity of the user. The others detection section 40 may detect a person appearing in the captured image using a known contour detection technique.

The behavior determination section 42 determines the action, in other words, the behavior of the VR pet in the VR movie theater. For example, in a case where the user (user's avatar) has entered the lobby of the VR movie theater, the behavior determination section 42 may determine a behavior of welcoming the user by wagging the tail as the behavior of the VR pet. Further, in a case where the fun button operation has been detected by the operation detection section 30, the behavior determination section 42 may determine a behavior of expressing enjoyment. Further, in a case where the sad button operation has been detected by the operation detection section 30, the behavior determination section 42 determines a behavior of expressing sadness.

Further, when the user's utterance of “come” has been detected by a voice detection section, not illustrated (or a predetermined button operation has been input), the behavior determination section 42 may determine a behavior of approaching the user as the behavior of the VR pet. Further, when the user's utterance of “sit” has been detected by the voice detection section (or a predetermined button operation has been input), the behavior determination section 42 may determine a behavior of sitting as the behavior of the VR pet.

Further, the behavior determination section 42 determines the action and the behavior of the VR pet according to the attribute information (e.g., learning data) of the pet robot 5 acquired by the attribute acquisition section 38. For example, the behavior determination section 42 may determine the action corresponding to the recent mood (good or bad) of the pet robot 5 as the action of the VR pet. Further, the behavior determination section 42 may acquire the pet's name indicated by the learning data, and in a case where call of the pet's name has been detected by the voice detection section, not illustrated, the behavior determination section 42 may determine a behavior of responding to the call. Further, the learning data may also include information regarding tricks (such as paw, sit, and lie down) learned by the pet robot 5. The behavior determination section 42 may determine the behavior of the VR pet so that a trick corresponding to the operation of the input apparatus 16 performed by the user or the user's utterance is performed.

Further, the behavior determination section 42 changes the behavior of the VR pet on the basis of data concerning the frequency of visit of the user stored in the visit frequency storage section 24. In the embodiment, in a case where the frequency of visit is relatively high, specifically, in a case where the interval of visit between last time and this time is less than a predetermined threshold (e.g., less than one week), the behavior determination section 42 determines a behavior of expressing closeness to the user (user's avatar) as the behavior of the VR pet. The behavior of expressing closeness may be one or a combination of (1) running to the user and jumping around the user, (2) immediately responding to the user's instruction, and (3) performing a special behavior in response to the fun button operation or the sad button operation.

On the other hand, in a case where the frequency of the user's visit is relatively low, specifically, in a case where the interval of visit between last time and this time is equal to or more than the predetermined threshold (e.g., one week or longer), the behavior determination section 42 determines a behavior indicating that the VR pet is estranged from the user (user's avatar) as the behavior of the VR pet. The behavior indicating estrangement may be one or a combination of (1) not responding to a single call, (2) not responding to (ignoring) the user's instruction (command), (3) not approaching the user, and (4) turning away from the user.

Further, in a case where the others detection section 40 has detected the appearance of a person different from the user in the vicinity of the user, the behavior determination section 42 determines a special alerting behavior for informing the user thereof as the behavior of the VR pet. The alerting behavior may be one or a combination of (1) barking toward the surroundings or the back of the user, and (2) biting and pulling the user's cloth.

The action record transmission section 44 transmits data concerning the action of the VR pet determined by the behavior determination section 42 and displayed in the VR image (hereinafter also referred to as “VR action history”) to the distribution server 3. The distribution server 3 causes the pet robot 5 to store the VR action history transmitted from the information processing apparatus 10 via the pet management server 7. The pet management server 7 may record the VR action history in the learning data of the pet robot 5.

The posture detection section 46 detects the position and posture of the HMD 100 using a known head tracking technique on the basis of the captured image output from the imaging apparatus 14 and the posture information output from the posture sensor 124 of the HMD 100. In other words, the posture detection section 46 detects the position and posture of the head of the user wearing the HMD 100.

The emotion acquisition section 48 acquires, from the distribution server 3, emotion data indicating emotion (enjoyment, sadness, or the like) of one or more of other users who are viewing the same video content in the same session as the user. In a case where the degree of a particular emotion of the user and the other users has reached a predetermined threshold or greater on the basis of the emotion data acquired by the emotion acquisition section 48, the controller control section 54 vibrates the input apparatus 16 in a mode associated with the particular emotion.

For example, in a case where the emotion of enjoyment of the user and the other users has reached a predetermined threshold or greater, the controller control section 54 may vibrate the input apparatus 16 in a mode associated with the enjoyment. For example, the controller control section 54 may vibrate the input apparatus 16 rhythmically. On the other hand, in a case where the emotion of sadness of the user and the other users has reached a predetermined threshold or greater, the controller control section 54 may vibrate the input apparatus 16 in a mode associated with sadness. For example, the controller control section 54 may vibrate the input apparatus 16 slowly for a long period of time.

The image generation section 50 generates a VR image of the VR movie theater according to the user operation detected by the operation detection section 30. Further, the image generation section 50 generates a VR image whose content matches the position and posture of the HMD 100 detected by the posture detection section 46. The image output section 52 outputs the data of the VR image generated by the image generation section 50 to the HMD 100 and causes the HMD 100 to display the VR image.

Specifically, the image generation section 50 generates a VR image which includes the VR pet image and in which the VR pet image behaves in a mode determined by the behavior determination section 42. For example, the image generation section 50 generates a VR image in which the VR pet image behaves in a mode corresponding to the frequency of the user's visit to the VR space. Further, in a case where the others detection section 40 has detected approach of another person to the user, the image generation section 50 generates a VR image in which the VR pet image behaves in a mode of informing the user thereof.

Further, the image generation section 50 generates a VR image including an image (in other words, a reproduction result) of video content stored in the content storage section 20. Further, in a case where a friend has joined the user's session, the image generation section 50 generates a VR image including an avatar image of the friend. Further, the image generation section 50 changes the VR image according to emotion data acquired by the emotion acquisition section 48.

An operation of the entertainment system 1 having the configuration described above will be described.

The user activates the video viewing application on the information processing apparatus 10. The image generation section 50 of the information processing apparatus 10 causes the HMD 100 to display a VR image representing the space of the lobby of the VR movie theater and including the VR pet image of the user.

The attribute acquisition section 38 of the information processing apparatus 10 acquires, via the distribution server 3, the attribute information regarding the pet robot 5 registered in the pet management server 7. The behavior determination section 42 of the information processing apparatus 10 determines a behavior mode of the VR pet according to the attribute information of the pet robot 5. A VR image in which the VR pet image behaves in the mode determined by the behavior determination section 42 is caused to be displayed by the image generation section 50. With the entertainment system 1 according to the embodiment, the VR pet that takes over the attribute of the pet robot 5 in the real space can be provided to the user, and a highly entertaining VR viewing experience can be provided to the user.

Further, the behavior determination section 42 changes the degree of intimacy of the VR pet to the user by changing the behavior mode of the VR pet according to the frequency of the user's visit to the VR movie theater. This allows the VR pet to perform a behavior similar to that of a real pet and can promote the user to visit the VR movie theater.

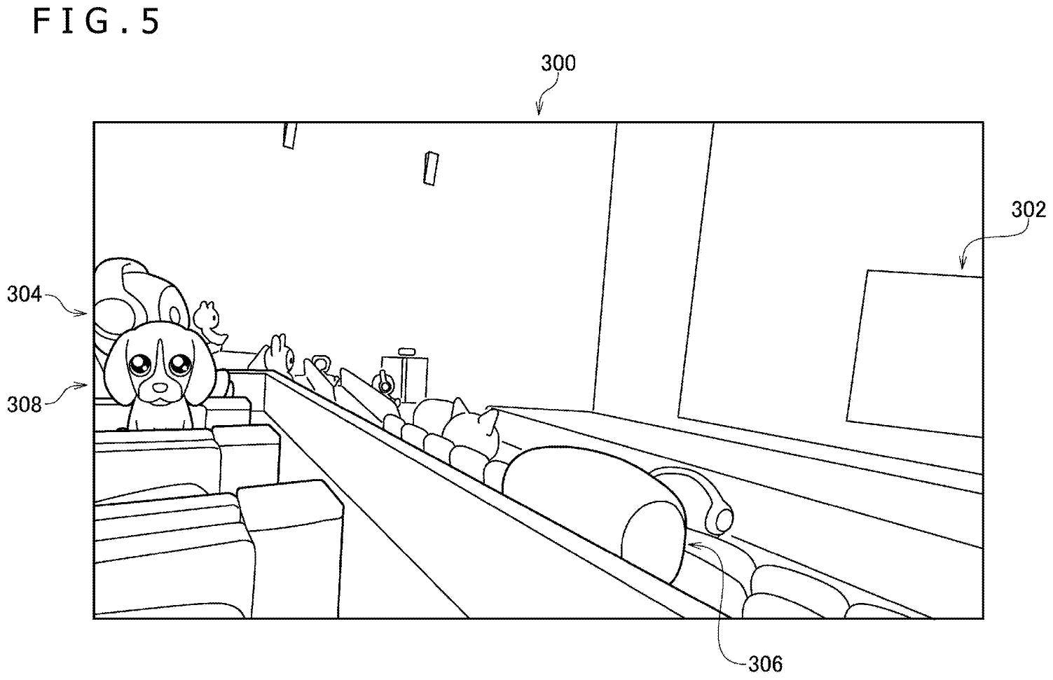

After purchasing a ticket at the lobby, the user can enter the screen room together with the VR pet. FIG. 5 illustrates an example of the VR image. A VR image 300 in this figure represents the screen room of the VR movie theater. In the screen room, a screen 302, a dummy character 304, and an another-user avatar 306 are disposed. Video content is displayed on the screen 302. The another-user avatar 306 represents another user. Further, a VR pet 308 of the user is seated next to the user. It is noted that the content acquisition section 32 of the information processing apparatus 10 may acquire information regarding another user who is simultaneously viewing the same video content as the user from the server, and the image generation section 50 may include the another-user avatar 306 in the VR image according to the acquired information.

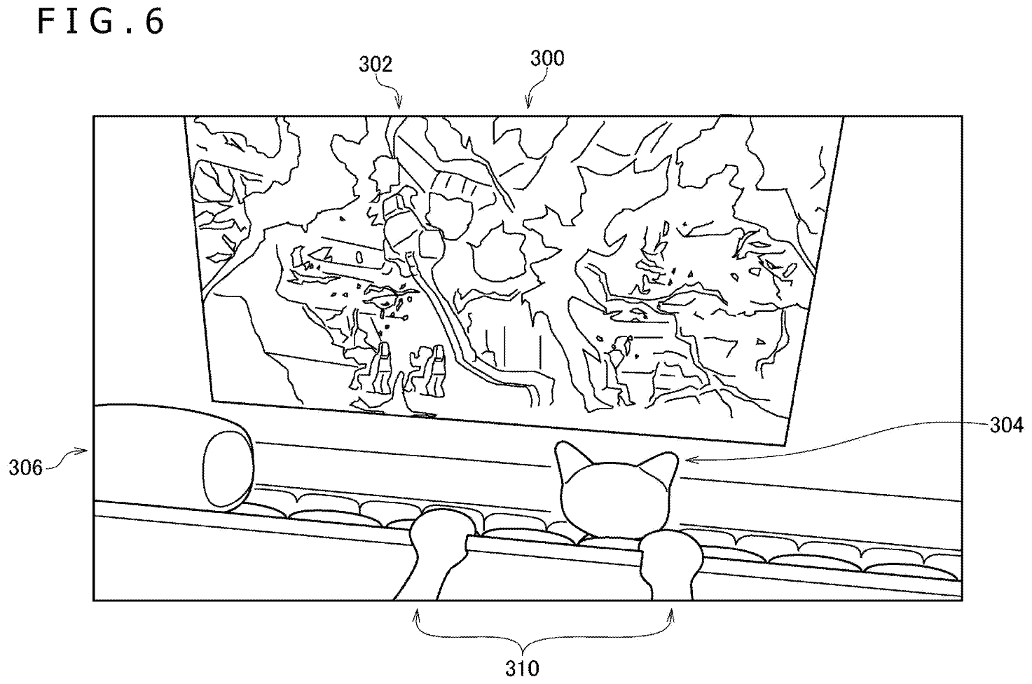

FIG. 6 also illustrates an example of the VR image. In the VR image 300 in this figure, video content is displayed on the screen 302. Arms 310 are images corresponding to the user's arms as seen from the first-person perspective. When the fun button operation has been input from the user, the image generation section 50 of the information processing apparatus 10 causes the user's avatar image to behave in a mode of expressing enjoyment, such as raising the arms 310 or clapping. On the other hand, when the sad button operation has been input from the user, the image generation section 50 of the information processing apparatus 10 causes the user's avatar image to behave in a mode of expressing sadness, such as covering the face with the arms 310 or crying.

The behavior determination section 42 of the information processing apparatus 10 determines the behavior of the VR pet in response to the fun button operation and the sad button operation. For example, in a case where the fun button operation has been input, the behavior determination section 42 may determine a behavior of expressing happiness (such as wagging the tail cheerfully). On the other hand, in a case where the sad button operation has been input, the behavior determination section 42 may determine a behavior of expressing sadness (such as lying down cheerlessly).

Further, the emotion transmission section 34 of the information processing apparatus 10 transmits emotion data of the user to the distribution server 3, and the distribution server 3 distributes the emotion data to information processing apparatuses of other users (such as friends) who are viewing the same video content as the user. The emotion acquisition section 48 of the information processing apparatus 10 receives the emotion data of each of the other users from the distribution server 3. The image generation section 50 causes each another-user avatar 306 to behave so as to express the emotion indicated by the corresponding emotion data. This allows the user to recognize the emotions of the other users and also to empathize with the emotions of the other users, thereby further increasing the sense of immersion in the VR space.

As already described, the emotion acquisition section 48 of the information processing apparatus 10 acquires the emotion data of each of other users who are viewing the same video content as the user. The image generation section 50 may cause a plurality of meter images, which correspond to a plurality of types of emotions that the user and the other users may have, to be displayed in the VR image. For example, the image generation section 50 may cause a meter image corresponding to enjoyment and a meter image corresponding to sadness to be displayed on a stage, a ceiling, or the like of the screen room. The image generation section 50 may change the mode of the meter image for each emotion according to the degree of each emotion of the user and the other users (e.g., the number of fun button operations or the number of sad button operations). With such meter images, the trend (atmosphere) of the emotions of the entire viewers viewing the same video content can be presented to the user in an easy-to-understand manner.

Further, in a case where the degree of a particular emotion of the user and the other users has reached the predetermined threshold or greater, the image generation section 50 may cause a VR image, which is in a mode associated with the particular emotion, to be displayed. For example, in a case where enjoyment of the user and the other users has reached the predetermined threshold or greater, the image generation section 50 may change part of the screen room (such as an area around the screen or the ceiling) to a warm color (such as orange or yellow). The threshold described above may be such that the number of fun button operations has reached the predetermined threshold or greater or a majority of viewers viewing the same video content have input the fun button operation.

On the other hand, in a case where the sadness of the user and the other users has reached the predetermined threshold or greater, the image generation section 50 may change part of the screen room (such as an area around the screen or the ceiling) to a cold color (such as blue or purple). The threshold described above may be such that the number of sad button operations has reached the predetermined threshold or greater or a majority of viewers viewing the same video content have input the sad button operation.

Further, in a case where the degree of a particular emotion of the user and the other users has reached the predetermined threshold or greater, the behavior determination section 42 may determine an action associated with the particular emotion as the action of the VR pet. For example, in a case where enjoyment of the user and the other users has reached the predetermined threshold or greater, the behavior determination section 42 may determine a behavior of expressing happiness (such as wagging the tail cheerfully). On the other hand, in a case where sadness of the user and the other users has reached the predetermined threshold or greater, the behavior determination section 42 may determine a behavior of expressing sadness (such as lying down cheerlessly).

It is noted that in the lobby, the user can select a menu to invite a friend to the user's session. In a case where the menu described above has been selected, the friend communication section 36 of the information processing apparatus 10 transmits a message inviting the friend to the user's session to an information processing apparatus (not illustrated) of the friend. The friend communication section 36 receives a notification transmitted from the information processing apparatus of the friend. This notification indicates that the friend has joined the user's session. The image generation section 50 causes an avatar image of the friend to be displayed in the VR images of the lobby and the screen room.

In this case, the distribution server 3 synchronizes the distribution of the video content to the information processing apparatus 10 with the distribution of the same video content to the information processing apparatus of the friend. The user and the friend can view the same video content at the same time as if they were in the same place in reality.

The action record transmission section 44 of the information processing apparatus 10 reflects a VR action history in the pet robot 5 via the distribution server 3. The VR action history indicates the action content of the VR pet in the virtual movie theater. Accordingly, the action of the VR pet in the virtual reality space can be reflected in the action of the pet robot 5 in the real space. For example, in a case where the VR action history indicates intimate action between the user and the VR pet, the pet robot 5 in the real space can also be made to behave intimately to the user.

It is noted that the VR action history may include data concerning the action of the user instead of or together with the action of the VR pet. Accordingly, the record of the action of the user (petting, playing, or the like) toward the VR pet in the virtual reality space can be reflected in the action of the pet robot 5 in the real space. For example, the user's interaction with the VR pet in the virtual reality space can improve the intimacy between the user and the pet robot 5 in the real space.

When the others detection section 40 of the information processing apparatus 10 has detected the approach of another person to the user during display of the VR image on the HMD 100, the behavior determination section 42 determines the alerting behavior for informing the user thereof as the behavior of the VR pet. The image generation section 50 causes the HMD 100 to display a VR image in which the VR pet alerts the user. As illustrated in FIG. 1, it is difficult for the user wearing the HMD 100 to check the user's surroundings. However, the alerting behavior of the VR pet enables the user to pay attention to the user's surroundings and also speak to another person if necessary.

The present invention has been described above on the basis of the embodiment. The above-described embodiment is an exemplification and it is to be understood by those skilled in the art that various modifications can be made to combinations of each constituent component or each processing process in the embodiment and that such modifications also fall within the scope of the present invention.

A first modification will be described. The entertainment system 1 may accommodate a plurality of users using the video viewing application in the same game session by free matching and make the plurality of users view the same video content at the same time. For example, in a case where the video content includes a PV (promotion video) section and a main body (such as a main part of a movie) section, users who have purchased tickets for the same video content may be accommodated in the same game session during a period between the start of the video content and the end of the PV section (before the start of the main body section).

In this case, the content acquisition section 32 of the information processing apparatus 10 may acquire, from the distribution server 3, information (such as avatar type, seat information, and emotion data) regarding the other users accommodated in the same game session. The image generation section 50 may generate a VR image (screen room image) including avatar images of the other users.

A second modification will be described. In the embodiment described above, the information processing apparatus 10 acquires the attribute information regarding the pet robot 5 via the pet management server 7 and the distribution server 3. As a modification, the information processing apparatus 10 may communicate with the pet robot 5 via P2P (peer-to-peer) and acquire the attribute information directly from the pet robot 5.

A third modification will be described. In the embodiment described above, the pet robot is exemplified as the first object that acts in response to the action of the user in the real space. The technique described in the embodiment can be applied to any of various objects that act in response to the action of the user in the real space without limiting to the pet robot. For example, the first object may be a humanoid robot or an electronic device (such as a smart speaker) that can talk with humans. Alternatively, the first object may also be a real animal pet (referred to as a “real pet”). In this case, the user may input attribute information regarding the real pet into the information processing apparatus 10 or may register the attribute information in the distribution server 3 using a predetermined electronic device.

A fourth modification will be described. The second object that acts in response to the action of the user in the virtual reality space may be a character appearing in an animated cartoon, a game, or the like without limiting to the user's pet. The information processing apparatus 10 may further include a switching section (and a purchasing section) which allows the user to select a pet or a character to interact with from a plurality of types of pets or characters for free or for a fee and makes the selected pet or character appear in the virtual reality space. When the user has entered the lobby, the image generation section 50 of the information processing apparatus 10 may cause a VR image including the pet or the character selected by the user to be displayed.

In the embodiment described above, at least some of the functions included in the information processing apparatus 10 may be included in the distribution server 3 or the HMD 100. Further, in the embodiment described above, a plurality of computers may cooperate with each other to implement the functions included in the information processing apparatus 10.

Any combination of the above-described embodiment and modifications is also useful as an embodiment of the present disclosure. A new embodiment resulting from the combination has combined effects of the combined embodiment and modifications. Further, it is also to be understood by those skilled in the art that the function to be fulfilled by each constituent element described in the claims is implemented by one of the individual constituent components described in the embodiment and modifications or by cooperation therebetween.

### REFERENCE SIGNS LIST

1 Entertainment system
3 Distribution server
5 Pet robot
10 Information processing apparatus
14 Imaging apparatus
24 Visit frequency storage section
38 Attribute acquisition section
40 Others detection section
42 Behavior determination section
44 Action record transmission section
50 Image generation section
52 Image output section
100 HMD

### INDUSTRIAL APPLICABILITY

This invention can be applied to a system that generates an image of a virtual reality space.

1. An information processing system comprising:
an acquisition section configured to acquire, from an external apparatus, attribute information regarding a first object that moves in response to an action of a user in a real space;
a determination section configured to, for an object image representing a second object that moves in response to an action of the user in a virtual reality space, determine a behavior mode of the object image in the virtual reality space according to the attribute information acquired by the acquisition section;
a generation section configured to generate a virtual reality image in which the object image behaves in the mode determined by the determination section; and
an output section configured to cause a display apparatus to display the virtual reality image generated by the generation section,
wherein the determination section further determines the behavior mode of the object image on a basis of data concerning another user acting together with the user in the virtual reality space.

2. The information processing system according to claim 1, wherein
the first object is a robot, and
the acquisition section acquires the attribute information transmitted from the first object.

3. The information processing system according to claim 2, further comprising:
a transmission section configured to transmit data concerning at least one of the action of the user and an action of the second object in the virtual reality space to the external apparatus to cause the first object to reflect the action in the virtual reality space.

4. The information processing system according to claim 1, further comprising:
a storage section configured to store data concerning a frequency with which the user has visited the virtual reality space,
wherein the determination section changes the behavior mode of the object image on a basis of the data concerning the frequency.

5. The information processing system according to claim 1, further comprising:
an imaging section configured to capture an image of a space including the user wearing a head-mounted display,
wherein the generation section generates a virtual reality image to be displayed on the head-mounted display, and in a case where a person different from the user appears in the image captured by the imaging section, the generation section generates the virtual reality image in which the object image behaves in a mode of informing the user of the appearance of the person different from the user.

6. A display method performed by a computer, comprising:
acquiring, from an external apparatus, attribute information regarding a first object that moves in response to an action of a user in a real space;
for an object image representing a second object that moves in response to an action of the user in a virtual reality space, determining a behavior mode of the object image in the virtual reality space according to the attribute information acquired by the acquiring;
generating a virtual reality image in which the object image behaves in the mode determined by the determining; and
causing a display apparatus to display the virtual reality image generated by the generating,
wherein the determining further determines the behavior mode of the object image on a basis of data concerning another user acting together with the user in the virtual reality space.

7. A non-transitory, computer readable storage medium containing a computer program, which when executed by a computer causes the computer to perform a display method by carrying out actions, comprising:
acquiring, from an external apparatus, attribute information regarding a first object that moves in response to an action of a user in a real space;
for an object image representing a second object that moves in response to an action of the user in a virtual reality space, determining a behavior mode of the object image in the virtual reality space according to the attribute information acquired by the function of acquiring;
generating a virtual reality image in which the object image behaves in the mode determined by the function of determining; and
causing a display apparatus to display the virtual reality image generated by the function of generating,
wherein the determining further determines the behavior mode of the object image on a basis of data concerning another user acting together with the user in the virtual reality space.
